(19) United States
(12) Patent Application Publication
(10) Pub. No.: US 2021/0229490 A1
(43) Pub. Date: Jul. 29, 2021

(54) DETACHABLE WHEEL ASSEMBLY

(71) Applicant: BASTA IP INC., Bellevue, WA (US)

(72) Inventors: Gene Thompson, Bellevue, WA (US); José López, Tacoma, WA (US)

(21) Appl. No.: 17/155,917

(22) Filed: Jan. 22, 2021

Related U.S. Application Data
(60) Provisional application No. 62/965,092, filed on Jan. 23, 2020.

(51) Int. Cl. B60B 33/00

(52) U.S. Cl. CPC B60B 33/001; B60B 33/0023

(57) ABSTRACT

A detachable wheel assembly having a clamp, a first translation assembly coupled to the clamp and a slide assembly coupled to the clamp. The wheel assembly further includes a second translation assembly coupled to the slide assembly, an axle coupled to the second translation assembly, and a wheel coupled to the axle. The wheel assembly is attached to a support of a structure and one or more of the translation assemblies or the slide assemblies are manipulated to lift the structure off the ground. Once the structure is off the ground, the structure can be moved via the wheel on the axle.

### BACKGROUND

### Technical Field

The present disclosure relates to a detachable wheel assembly for use in transporting structures.

### Description of the Related Art

Systems have been developed to assist with moving certain large or heavy structures. For example, handcarts typically include wheels and are designed to act as a lever to assist with moving large or heavy structures. However, handcarts are not a practical solution for moving all types of structures, and especially structures that are too large to fit on the cart. In response, temporary wheel assemblies have been developed that can be temporarily coupled to a structure to allow for transportation of the structure. However, known temporary wheel assemblies are difficult to attach to the structure and do not provide an adequate lifting height range, which limits the applicability of known temporary wheel assemblies.

### BRIEF SUMMARY

In one or more implementations of the present disclosure, a detachable wheel assembly is provided that includes a clamp including a first jaw and a second jaw, a first translation assembly coupled to the first jaw and structured to move the first jaw towards and away from the second jaw, a slide assembly coupled to the first translation assembly and to the second jaw and structured to move the second jaw towards and away from the first jaw, a wheel axle, and a second translation assembly coupled to the first translation assembly, the slide assembly, and the wheel axle, the second translation assembly structured to move the first translation assembly and the slide assembly towards and away from the wheel axle.

In accordance with another aspect of the present disclosure, the detachable wheel assembly includes: a first pair of flanges and a second pair of flanges coupled to the axle, the first pair of flanges separated by a first distance and the second pair of flanges separated by a second distance; a float assembly including a fork having one or more hooks structured to be coupled to the wheel axle between a corresponding one of the first pair of flanges and the second pair of flanges, a frame coupled to the fork, and one or more floats coupled to the frame, wherein the fork is structured to move toward and away from the frame to adjust a position of the one or more floats relative to the wheel axle; and the one or more floats include a first float and a second float, the first float and the second float positioned on opposite sides of a wheel coupled to the wheel axle.

In accordance with a further aspect of the present disclosure, the detachable wheel assembly includes: the slide assembly including a tube coupled to the second jaw of the clamp, the tube including a plurality of first holes through the tube, a plate coupled to the second translation assembly and including a second hole through the first plate, and a pin structured to be received in at least one of the plurality of first holes and the second hole, wherein a position of the plate is adjustable relative to the tube by removing the pin, sliding the plate assembly along the tube, and inserting the pin in a different one of the plurality of first holes; and the plurality of first holes being a plurality of first pairs of holes through the tube and the plate is a first plate, the slide assembly further including a second plate coupled to the second translation assembly and including a third hole through the second plate, wherein the position of the first plate and the second plate is adjustable relative to the tube by removing the pin, sliding the first plate and the second plate along the tube, and inserting the pin in one of the plurality of first pairs of holes, the second hole, and the third hole.

In accordance with still yet another aspect of the present disclosure, the detachable wheel assembly includes: a handle assembly coupled to the second translation assembly, the handle assembly including a pair of links coupled to the second translation assembly and a first handle and a second handle coupled to the pair of links, the first handle and the second handle positioned on opposite sides of the second translation assembly.

In one or more implementations of the present disclosure, a detachable wheel assembly is provided that includes a clamp, a first translation assembly coupled to the clamp, a slide assembly coupled to the clamp, a second translation assembly coupled to the slide assembly, an axle coupled to the second translation assembly, a wheel coupled to the axle.

In accordance with another aspect of the present disclosure, the detachable wheel assembly includes: the clamp including a first jaw and a second jaw, the first jaw coupled to the first translation assembly and the second jaw coupled to the slide assembly, the first jaw further including a flat portion and a recess, wherein the recess defines sidewalls that are flat, curved or sloped; and a float assembly including a fork having one or more hooks structured to be coupled to the axle, a frame coupled to the fork, and one or more floats coupled to the frame, wherein the fork is structured to move toward and away from the frame to adjust a position of the one or more floats relative to the axle.

In accordance with a further aspect of the present disclosure, the detachable wheel assembly includes: the first translation assembly including a first tube coupled to the clamp, a second tube structured to slidably receive the first tube in a telescoping manner, a first screw coupled to the second tube and extending through at least one wall of each of the first and second tubes, and a first nut on the first screw, the first nut coupled to the first tube and structured to translate along the first screw in response to rotation of the first screw; the second translation assembly including an inner tube coupled to the axle, an outer tube structured to slidably receive the inner tube, a second screw coupled to the outer tube and extending through at least one wall of each of the inner and outer tubes, and a second nut on the second screw, the second nut coupled to the inner tube and structured to translate along the second screw in response to rotation of the second screw; and a handle assembly coupled to the second translation assembly, including two handles on opposing sides of the second translation assembly connected to each other by links coupled to the second translation assembly.

In accordance with yet a further aspect of the present disclosure, the detachable wheel assembly includes: the slide assembly including a central tube coupled to the clamp and having a first side and a second side opposite the first side with a plurality of pairs of first holes extending through the first and second sides of the central tube, each pair of first holes of the plurality of pairs of first holes spaced relative to each other pair of first holes along a height of the central tube, a first plate assembly coupled to the second translation assembly and having a second hole extending through the first plate assembly, a second plate assembly coupled to the second translation assembly and having a third hole extending through the second plate assembly, and a pin structured to be received in one of the pairs of the first holes, the second hole, and the third hole, wherein a position of the first and second plate assemblies relative to the central tube is adjustable by removing the pin, sliding the plate assemblies along the central tube, and inserting the pin in a different pair of the plurality of pairs of first holes, the second hole, and the third hole.

In accordance with another implementation of the present disclosure, a method is provided that includes adjusting a slide assembly coupled to a first jaw of a clamp until the first jaw of the clamp is in physical contact with a support of a structure, rotating a first screw of a first translation assembly coupled to a second jaw of the clamp until the second jaw of the clamp is in physical contact with the support of the structure, rotating a second screw of a second translation assembly coupled to an axle to adjust a height of the axle and a height of a wheel coupled to the axle relative to the support, moving the structure from a first location to a second location, and removing the clamp from the support of the structure.

In accordance with a further aspect of the present disclosure, the method includes: removing a pin from one hole of a plurality of holes in a fork of a float assembly, adjusting the fork relative to a support of the float assembly, coupling hooks coupled to the fork to the axle, inserting the pin into a different hole of the plurality holes, and rotating the second screw of the second translation assembly; removing a pin from a first hole in a first plate coupled to the second translation assembly, a second hole in a second plate coupled to the second translation assembly, and one pair of holes of a plurality of pairs of holes in a tube of the slide assembly coupled to the first jaw of the clamp, sliding the first plate and the second plate along the tube, and inserting the pin into a different pair of holes of the plurality of pairs of holes, the first hole, and the second hole; rotating the first screw of the first translation assembly includes adjusting a height of a first tube relative to a second tube of the first translation assembly, the rotating including translating a first nut coupled to the first tube along the first screw via rotation of the first screw; and rotating the second screw of the second translation assembly includes adjusting a height of a third tube relative to a fourth tube of the second translation assembly, the rotating including translating a second nut coupled to the third tube along the second screw via rotation of the second screw.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the drawings, wherein:

FIG. 1 is an axonometric view of a detachable wheel assembly according to the present disclosure;

FIG. 2 is a front elevational view of the detachable wheel assembly of FIG. 1;

FIG. 3 is a rear elevational view of the detachable wheel assembly of FIG. 1;

FIG. 4 is a cross-sectional view of the detachable wheel assembly of FIG. 3;

FIG. 5 is a cross-sectional view of a first translation assembly of the detachable wheel assembly of FIG. 1;

FIG. 6 is a partial cross-sectional view of a second translation assembly of the detachable wheel assembly of FIG. 1;

FIG. 7 is an axonometric view of a lead screw and nut of the first translation assembly of FIG. 5;

FIG. 8 is an axonometric view of a lead screw and nut of the second translation assembly of FIG. 6;

FIG. 9 is a top plan view of the detachable wheel assembly of FIG. 1;

FIG. 10 is a cross-sectional view of a slide assembly of the detachable wheel assembly of FIG. 1;

FIG. 11 is an axonometric view of the detachable wheel assembly of FIG. 1 in a retracted configuration;

FIG. 12 is an axonometric view of a flotation assembly according to the present disclosure; FIG. 13 is an exploded view of the flotation assembly of FIG. 12;

FIG. 14 is an axonometric view of the flotation assembly of FIG. 12 coupled to a detachable wheel assembly according to the present disclosure; and

FIG. 15 is an axonometric view of a detachable wheel assembly with a handle according to the present disclosure.

### DETAILED DESCRIPTION

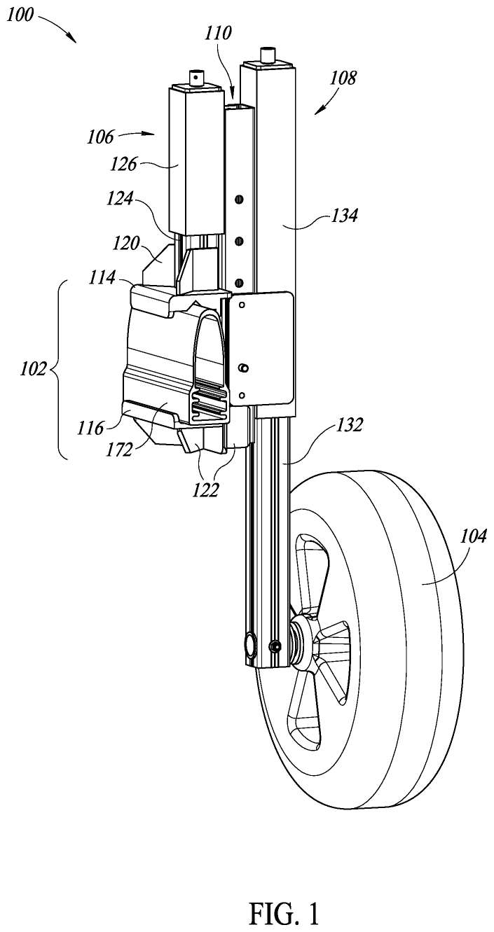

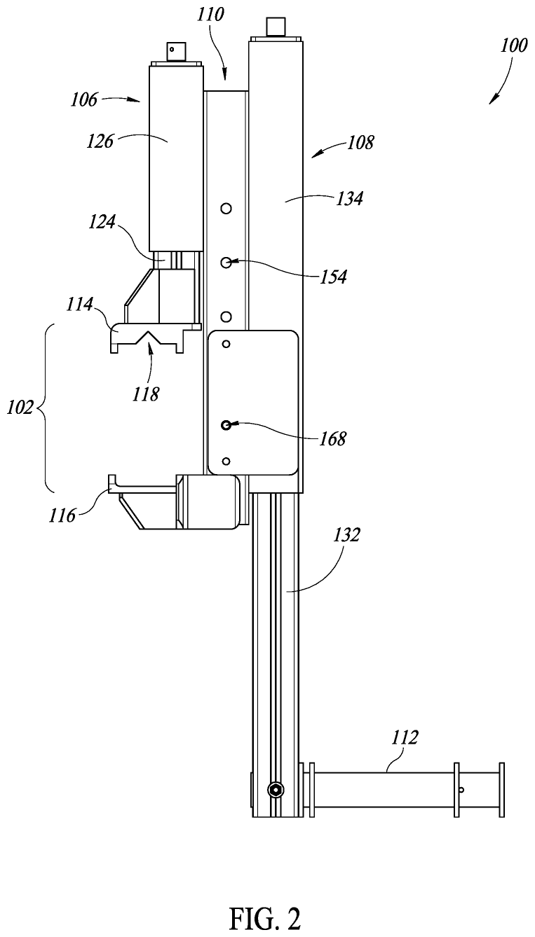

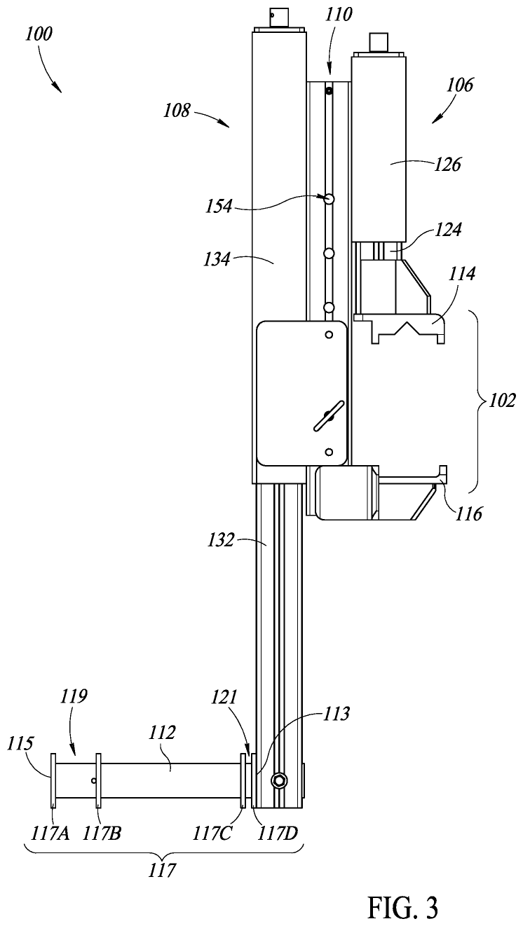

Referring initially to FIG. 1, shown therein is a detachable wheel assembly 100 according to the present disclosure. FIG. 2 is a front elevational view of the wheel assembly 100 and FIG. 3 is a rear elevational view of the wheel assembly 100. With reference to FIGS. 1-3, the detachable wheel assembly 100 includes a clamp 102 configured to grip a support 172 that is associated with a device to be transported (not shown). Although the present disclosure will proceed using a boat lift as an example of a device that can be transported with the wheel assembly 100, it is to be appreciated that the wheel assembly 100 can also be used to transport any number of other structures, which may require modification of the clamp 102 or the other features of the wheel assembly 100 described herein, which modifications would be known to one of skill in this technology.

The wheel assembly 100 includes a wheel 104, a first translation assembly 106, a second translation assembly 108, and a slide assembly 110. An axle 112 is coupled to the second translation assembly 108, and the wheel 104 is coupled to the axle 112 and structured to rotate about the axle 112. The wheel 104 can be any commercially available wheel and includes a tire constructed of plastic or rubber or any other like material.

The clamp 102 includes a first jaw 114 and a second jaw 116. The first jaw 114 is coupled to the first translation assembly 106 and the second jaw 116 is coupled to the slide assembly 110. The first translation assembly 106 is structured to move the first jaw 114 towards and away from the second jaw 116 and the slide assembly 110 is structured to move the second jaw 116 towards and away from the first jaw 114 to grip the support 172. In some implementations, the second translation assembly 108 cooperates with the slide assembly 110 to enable movement of the second jaw 116.

The second jaw 116 has a U-shaped structure with a base and two sidewalls perpendicular to the base that are each flat and planar to receive a square or rectangular support member of the object to be moved. The first jaw 114 has a similar structure, except the first jaw 114 includes a recess 118 extending into a base of the first jaw 114 that is structured to receive an irregularly shaped section of the support member 172 of the object to be moved. In some implementations, the recess 118 is centered with respect to the sidewalls of the first jaw 114 and has sidewalls that are flat, curved, or sloped in order to receive a correspondingly shaped support. The first jaw 114 can also be securely attached to a flat and planar support member via the flat and planar portions of the first jaw 114 shown on either side of the recess in FIG. 2. In some implementations, the second jaw 116 includes a recess similar to the other recess 118. As such, the clamp 102 is adapted to securely engage support members of various shapes and sizes without slipping or canting, such as support 172, which has a rounded top and stepped sides.

The first jaw 114 is coupled to the first translation assembly 106 with a plurality of plates 120, wherein each plate 120 has a flat portion and an angled portion disposed at a transverse angle to the flat portion. In addition, one or more of the plates 120 has a height that tapers over at least a portion of the width of the angled portion, as shown in FIG. 1. The second jaw 116 is coupled to the slide assembly 110 with second plates 122. The second plates 122 have a different size and shape than the first plates 120. For example, the second plates 122 may be L-shaped or may have a similar structure to the first plates 120.

In operation, the wheel assembly 100 engages the support 172 (FIG. 1) by manipulating the second translation assembly 108 or the slide assembly 110, or both, as explained below, until the support 172 is in contact with the second jaw 116. Then, an operator can manipulate the first translation assembly 106, as described herein, to move the first jaw 114 into contact with the support 172. The user continues to manipulate the first translation assembly 106 until the first jaw 114 and the second jaw 116 securely engage the support 172 with the sidewalls of each clamp 114, 116 restricting lateral movement of the support 172.

As such, the wheel assembly 100 uses a clamp 102 that is easily installed and removed from the support 172 and does not require numerous bolts and a bolt plate. The design of the clamp 102 and jaws 114, 116 also enables easier adjustments to the balance of the boatlift on the wheels 104 in a forward and aft direction. In one non-limiting example, if two wheel assemblies 100 are attached to a boat lift and, upon attempting to move the boat lift, it is determined that the boat lift is unbalanced, the jaws 114, 116 can be manipulated, as above, and the wheel assemblies 100 easily repositioned to provide improved balance of the boat lift over the wheels 100, which enables easier transportation of the boat lift.

FIG. 3 further illustrates that the axle 112 includes a first end 113 and a second end 115. The first end 113 is coupled to the second translation assembly 108 and the second end 115 is spaced from the second translation assembly 108 across the axle 112. As such, the first end 113 is a proximate end and the second end 115 is a distal end in some implementations. The axle further includes a plurality of flanges 117 coupled to the axle 112 and spaced along the axle 112. As shown in FIG. 3, the plurality of flanges 117 includes first flange 117A, second flange 117B, third flange 117C, and fourth flange 117D. The first flange 117A is coupled to the axle 112 at the second end 115 and the second flange is coupled the axle 112 and spaced from the first flange 117A by a first distance 119. The fourth flange 117D is coupled to the axle 112 at the first end 113 and the third flange 117C is coupled to the axle 112 and spaced from the fourth flange 117D by a second distance 121.

Each of the flanges 117 may be metal rings or other like structures with a central aperture adapted to receive the axle 112. The first and second distances 119, 121 correspond to areas of the axle 112 that are adapted to receive hooks of a floatation assembly to assist with moving lifts positioned in water, as explained further herein. The flanges 117 define the distances 119, 121 and constrain lateral movement of the hooks of the flotation assembly. In some implementations, the first distance 119 is greater than the second distance 121, while in one or more implementations, the distances 119, 121 are equal or the second distance 121 is greater than the first distance 119. Thus, the position of the flanges 117 and the distances 119, 121 can be adapted for use with hooks of different sizes or positions.

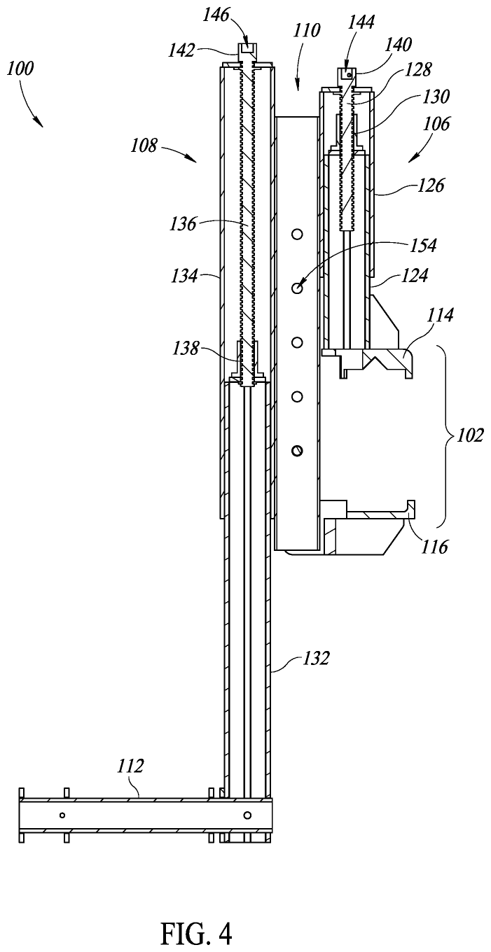

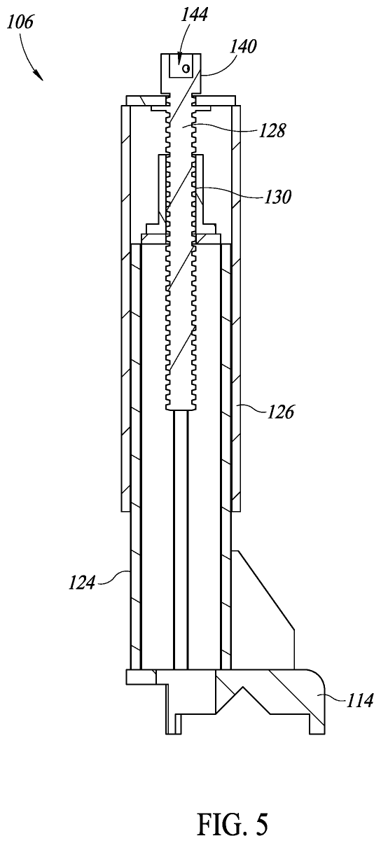

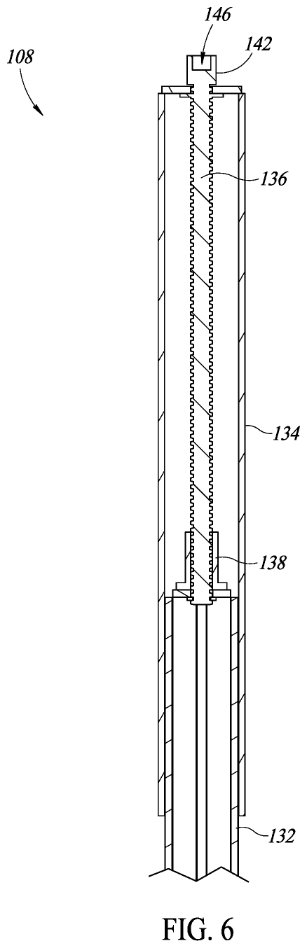

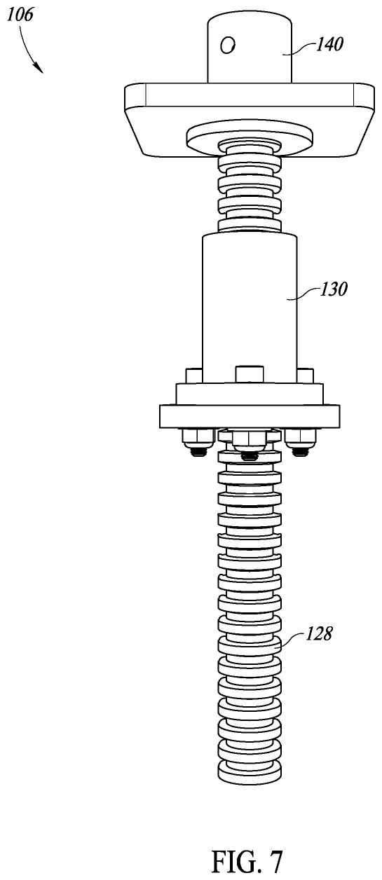

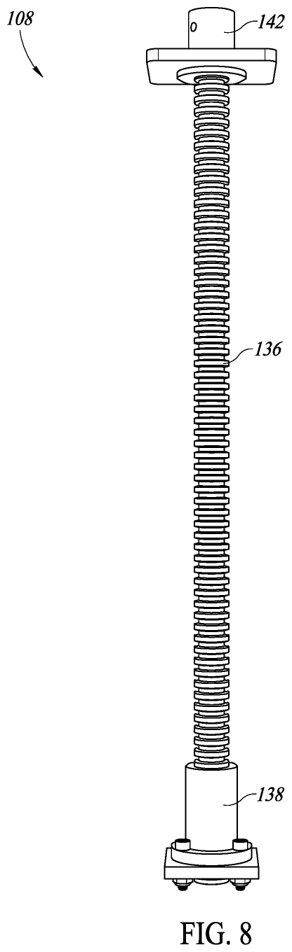

FIGS. 4-8 provide additional detail of the first translation assembly 106 and the second translation assembly 108. FIG. 4 is a cross-sectional view of the wheel assembly 100, FIG. 5 is a cross-sectional view of the first translation assembly 106, and FIG. 6 is a partial cross-sectional view of the second translation assembly 108. FIG. 7 is an axonometric view of a lead screw and nut assembly of the first translation assembly 106 and FIG. 8 is an axonometric view of a lead screw and nut assembly of the second translation assembly 108.

Beginning with FIG. 4 and with reference to FIG. 5 and FIG. 7, the first translation assembly 106 (which may also be referred to herein as a first actuator 106) includes a first tube 124 coupled to the clamp 102 and specifically, to the first jaw 114 of the clamp 102. A second tube 126 is structured to slidably receive the first tube 124 in a telescoping manner, as illustrated in FIG. 5. Thus, the first tube 124 may be referred to as a first piston 124 and the second tube 126 may be referred to herein as a first housing 126 for receiving the piston 124. The first translation assembly 106 further includes a first lead screw 128 coupling the first tube 124 to the second tube via nut 130 for longitudinal axial movement of the first tube 124 into and out of the second tube 126. The first lead screw 128 extends through at least one wall of each of the first and second tubes 124, 126 as shown in FIG. 4.

In some implementations, the first lead screw 128 is coupled to the second tube 126 and threadably engaged with a first nut 130 (see FIG. 7) coupled to the first tube 124. More specifically, the first translation assembly 106 includes a flange or washer welded to the second tube 126 at the interface between the second tube 126 and the first lead screw 128 that pushes up against the top of the second tube 126 as the screw 128 rotates. In one or more implementations, the first translation assembly 106 includes a thrust washer between the top of the second tube 126 and the flange or washer to enable smooth rotation regardless of the load applied to the first translation assembly 106. When the first lead screw 128 rotates, the nut 130 moves up and down the first lead screw 128 depending on the direction of rotation of the first lead screw 128 (e.g., clockwise or counterclockwise). The first lead screw 128 and first nut 130 may be an acme screw in some implementations. The first nut 130 is coupled to the first tube 124 of the first translation assembly 106, such that rotation of the first lead screw 128 and translation of the nut 130 along the first lead screw 128 results in movement of the first tube 124 into and out of the second tube 126. Because the first jaw 114 is coupled to the first tube 124, the movement of the first tube 124 relative to the second tube 126 via the first lead screw 128 and nut 130 adjusts a position of the first jaw 114 of the clamp 102 relative to the first translation assembly 106.

Turning to FIG. 6 and FIG. 8, with continuing reference to FIG. 4, the second translation assembly 108 (which may also be referred to herein as a second actuator 108) has a similar structure to the first translation assembly 106. In one non-limiting example, the second translation assembly 108 includes an inner tube 132 coupled to the axle 112 (see FIG. 4) and an outer tube 134 structured to slidably receive the inner tube 132 in a telescoping manner. The inner tube 132 may be referred to as a second piston 132 and the outer tube 134 may be referred to as a second housing 134 for receiving the piston 132. The second translation assembly 108 further includes a second lead screw 136 coupled to the outer tube 134 and extending through at least one wall of each of the inner and outer tubes 132, 134. In some implementations, the second translation assembly 108 includes a similar flange and washer assembly at the interface between the top of the outer tube 134 and the second lead screw 126 as described above for the first translation assembly 106. The second lead screw 136 is threadably engaged with a second nut 138 coupled to the inner tube 132 and structured to translate along the second lead screw 136 in response to rotation of the second lead screw 136. Because the second nut 138 is coupled to the inner tube 132, translation of the nut 138 along the second lead screw 136 results in longitudinal axial movement of the inner tube 132 into and out of the outer tube 134. In some implementations, the second lead screw 136 and the second nut 138 are an acme screw.

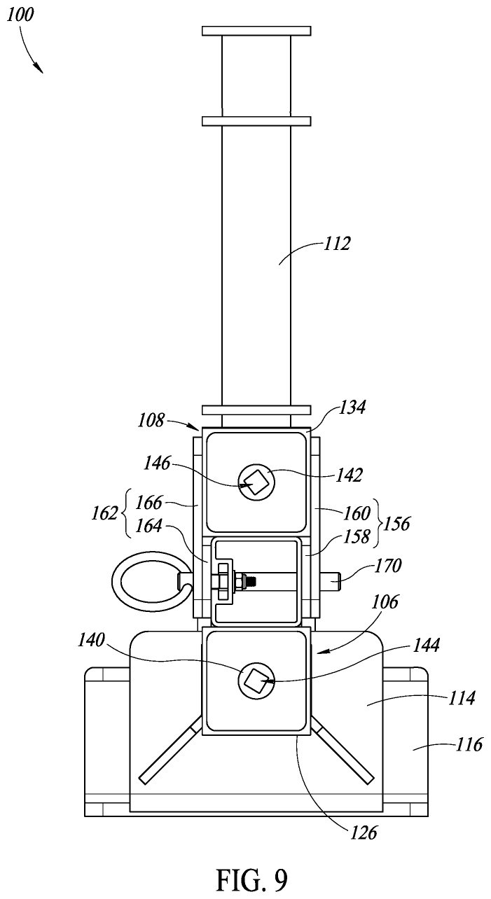

As shown in FIG. 5 and FIG. 6, the first lead screw 128 has a head 140 and the second lead screw 136 has a head 142. In some implementations, the heads 140, 142 are identical. The head 140 of the first lead screw 128 includes a one half inch square recess 144 structured to receive a one half inch square drive to rotate the first lead screw 128 (see FIG. 9), in some implementations. Similarly, the head 142 of the second lead screw 136 includes a one half inch square recess 146 structured to receive a one half inch square drive to rotate the second lead screw 136 (see FIG. 9). A user can manually or mechanically manipulate the first and second translation assemblies 106, 108 via a one half inch square drive inserted into heads 140, 142. The heads 140, 142 may also be modified to include recesses of other shapes and sizes.

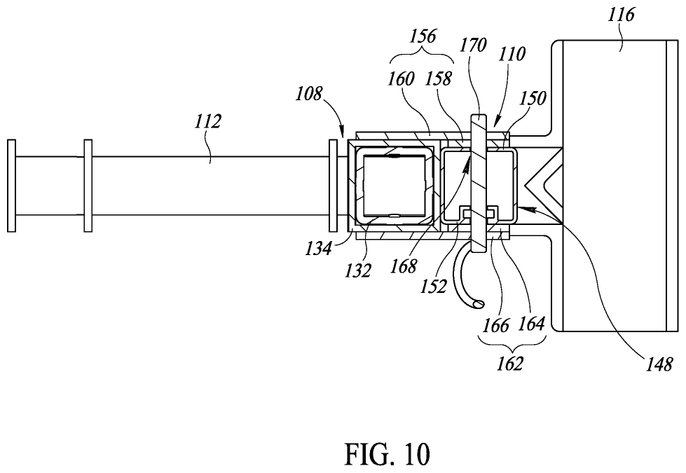

FIG. 9 and FIG. 10 illustrate the slide assembly 110 in additional detail. FIG. 9 is a top plan view of the detachable wheel assembly 100 and FIG. 10 is a cross-sectional view of the slide assembly 110. With reference to FIG. 9 and FIG. 10, the slide assembly 110 includes a central tube 148 coupled to the clamp 102 (see FIG. 2). In particular, the central tube 148 is coupled to the second jaw 116 of the clamp 102. The central tube 148 has a first side 150 and a second side 152 opposite the first side 150. As more clearly shown in FIGS. 2-3, a plurality of pairs of holes 154 extend through the first and second sides 150, 152 of the central tube 148. The holes on each side 150, 152 are aligned with corresponding holes on the other respective side 150, 152 in each pair of holes 154. Each of the pairs of holes 154 are spaced relative to each other along a height of the central tube 148. The slide assembly 110 further includes a first plate assembly 156 that has first and second plates 158, 160 coupled to the first side 150 of the central tube 148 and a second plate assembly 162 that has first and second plates 164, 166 coupled to the second side 152 of the central tube 148. Each of the plate assemblies 156, 162 includes a hole 168 extending through the respective plate assembly 156, 162 and configured to align with a corresponding pair of holes 154 of the plurality of pairs of holes 154 of the central tube 148.

A pin 170 is structured to be received in one of the pairs of holes 154, and each of the holes 168 through the plate assemblies 156, 162. The pin 170 is removable, such that a position of the first and second plate assemblies 156, 162 relative to the central tube 148 is adjustable by removing the pin, sliding the plate assemblies 156, 162 along the central tube 148, and inserting the pin 170 into a different aligned pair of holes 154 of the plurality of pairs of holes 154. In some implementations, the slide assembly 110 includes holes only on one side of the central tube 148 instead of the pairs of holes 154 through opposite sides of the tube 148.

In some implementations, the second plate 160 of the first plate assembly 156 and the second plate 166 of the second plate assembly 162 are welded or otherwise permanently coupled to the second translation assembly 108 and more particularly, to the outer tube 134 of the second translation assembly. As such, the position of the axle 112 can be adjusted by manipulating the second translation assembly 108, the slide assembly 110, or both. In some implementations, the first translation assembly 106 is coupled to the slide assembly 110 such that the position of the axle 112 can also be adjusted by manipulating the first translation assembly 106. Further, the position of the first translation assembly 106 relative to the second translation assembly 108 can be adjusted by manipulating the slide assembly 110. As such, the user has more flexibility to adjust the height of the wheel assembly 100 and thus the structure to be moved. Moreover, the first translation assembly 106, the second translation assembly 108, and the slide assembly 110 increase the lifting range of the wheel assembly 100 such that the wheel assembly 100 can be used in a wider range of applications.

In one non-limiting example, the additional lifting range of the wheel assembly 100 enables use of the wheel assembly 100 underwater and at greater water depths, such that the wheel assembly 100 can be used to move a boat lift into and out of a greater range of water depths, in addition to providing more clearance for moving the structure on land. Moreover, the design of the wheel assembly 100 reduces cost because the second translation assembly 108, which includes a comparatively expensive acme screw, is just long enough to raise the boatlift coupled to the wheel assembly 100 off the bottom of a body of water in some implementations, while the slide assembly 100 can be adjusted to accommodate a boatlift with its legs extended in deeper water.

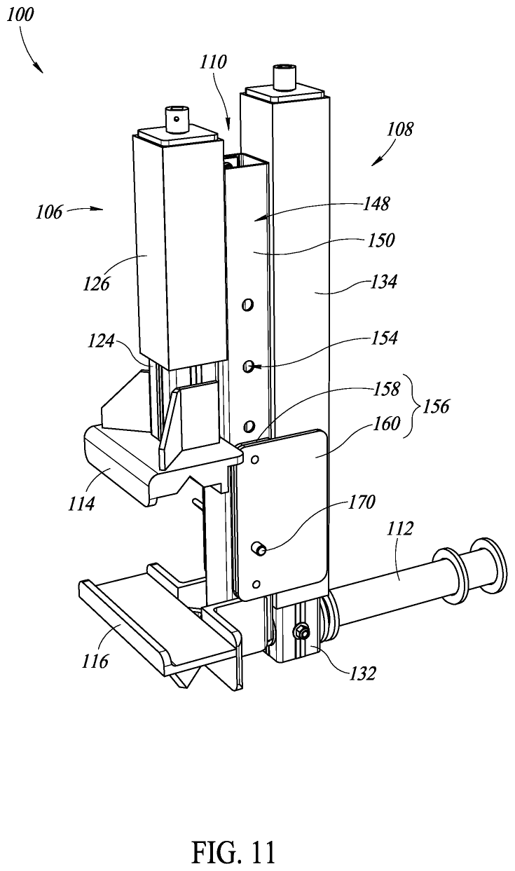

FIG. 11 illustrates the detachable wheel assembly 100 in a retracted configuration, whereas FIGS. 1-10 illustrate the detachable wheel assembly 100 in an extended configuration. Specifically, in use, and with continuing reference to FIGS. 1-10 the detachable wheel assembly 100 may be secured to a support 172 (see FIG. 1) of a structure to be moved with the wheel assembly 100 in the configuration shown in FIG. 11. In the retracted configuration, the structure is resting on the ground or a support surface and the wheel 104 is contacting the ground or spaced from the ground. The clamp 102 is secured to the support 172 by adjusting the first translation assembly 106 or sliding the slide assembly 110, or both. Then, the second translation assembly 108 is manipulated to extend the second translation assembly 108, which lifts the structure and associated support 172 away from the ground to leave the wheel 104 resting on the ground and supporting the structure. The lifting range of the assembly 100 may be selected by further manipulating the slide assembly 110 and the first translation assembly 106 in some implementations. Once the structure is off the ground, the structure can be rolled using the wheel 104. In some implementations, two identical wheel assemblies 100 are used on either side of the structure. In some implementations, three, four, five, six or more identical wheel assemblies 100 are used to move a structure. When multiple wheel assemblies 100 are used, they can be spaced equidistant about the structure to be moved, or they can be paired up proximate concentrated loads of the structure.

Thus, a method of lifting a structure using the detachable wheel assembly 100 of the present disclosure may include adjusting the slide assembly 110 coupled to the clamp 102 until the clamp 102 is in physical contact with the support 172. The adjusting includes manipulating the slide assembly 110 until the second jaw 116 is in physical contact with the support 172. Then, the method continues by rotating the first lead screw 128 of the first translation assembly 106 coupled to the clamp 102, including adjusting a height of the first tube 124 relative to the second tube 124 of the first translation assembly 106. The rotating may include translating the first nut 130 coupled to the first tube along the first lead screw 128 via rotation of the first lead screw 128 until the first jaw 114 of the clamp 102 is in physical contact with the support 172 of the structure to be moved. After these steps, the clamp 102 is securely coupled to the support 172.

The method further includes rotating the second lead screw 136 of the second translation assembly 108 with the second translation assembly 108 coupled to the axle 112 to adjust a height of the axle 112 and a height of the wheel 104 coupled to the axle 112 relative to the support 172. Rotating the second lead screw 136 includes adjusting a height of the inner tube 132 relative to the outer tube 134 of the second translation assembly 108 by translating the second nut 138 coupled to the inner tube 132 along the second lead screw 136 via rotation of the second screw 138. Then, the structured is moved from a first location, such as a shoreline, to second location such as an installation location or vice versa in one non-limiting example, and the method concludes by reversing the above steps to place the structure on a ground or support surface and removing the clamp 102 from the support 172 of the structure. The method may also include additional steps when the wheel assembly 100 is used with the float assembly, as described below.

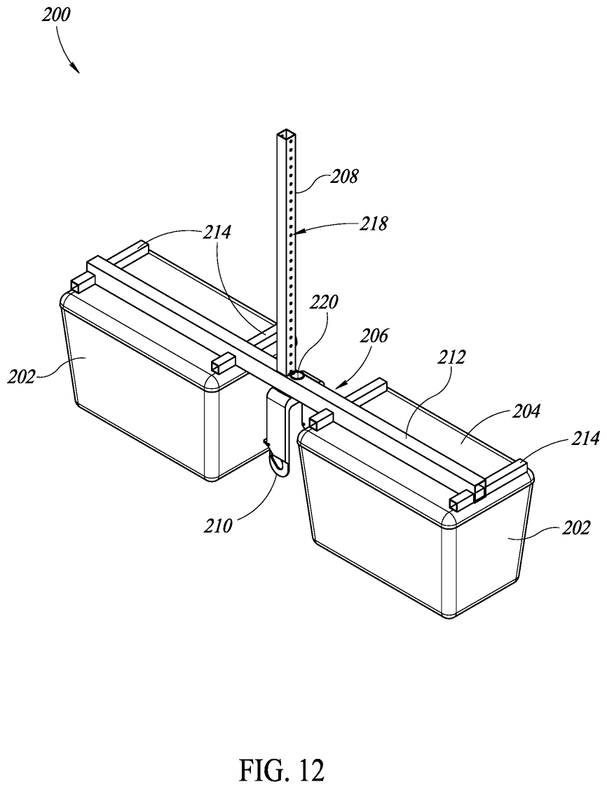

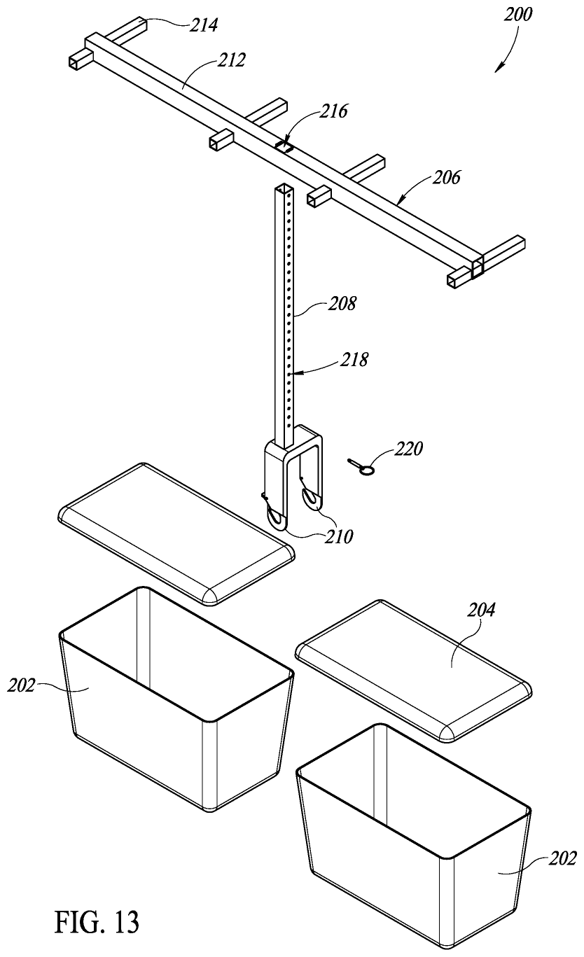

FIG. 12 is an axonometric view of one or more embodiments of a float assembly 200 (which may also be referred to herein as a flotation assembly) and FIG. 13 is an exploded view of the float assembly 200. With reference to FIG. 12 and FIG. 13, the float assembly 200 includes floats 202 sealed by lids 204. The lids 204 may be removable or may be permanently coupled to the floats 202. In some implementations, the floats 202 are empty and rely on air sealed in the floats 202 by the lids 204 to provide a buoyant force, while in one or more implementations, the floats 202 are filled with a material or gas. The material may be foam or another like material, which reduces buoyancy, but improves durability and safety by keeping water out of the floats 202 if the floats 202 are punctured. Alternatively, the lids 204 may be sealed to the floats 202 and filled with a gas more buoyant than air, such as helium, aerosols, or another like gas. Further, the floats may include aerogels filled with gas to increase buoyancy, in one or more implementations, such as hydrogen filled aerogels.

A frame 206 is attached to the lids 204 and a central supporting structure or fork 208. More specifically, the frame 206 includes a support 212, which may be a single, continuous piece of metal in some implementations, and a plurality of crossbars 214 coupled to the support 212. As shown in FIG. 12, the crossbars 214 are coupled to the lids 204 of the floats 202 and are positioned at opposite ends of the lids 204 in some implementations. In one or more implementations, the crossbars 214 are positioned anywhere along the lids 204. Further, the support 212 is positioned off-center of the lids 204 (or spaced from a centerline along a top surface of the lids 204) in order to accommodate a boatlift proximate the float assembly 220 without interference. However, the support 212 can similarly be positioned at any location relative to the lids 204 in some implementations. As shown in FIG. 13, the support 212 includes an aperture 216 structured to receive the fork 208.

The position or height of the fork 208 is adjustable relative to the frame 206. The fork 208 extends through the aperture 216 in the frame 206 and includes holes 218 spaced along a height of the fork 208 to receive a removable pin 220, as shown in FIG. 12. As such, the height of the fork 208 can be adjusted relative to the frame 206 by removing the pin 220, sliding the fork 208 relative to the frame 206, and inserting the pin 220 into a different hole 218 or set of holes 218 along the fork 208. In some implementations, there are holes 218 on only one side of the fork 208 for receiving the pin 220 while in one or more implementations, there are pairs of aligned holes 218 through the fork 208 for receiving the pin 220.

The fork 208 further includes a plurality of hooks 210 that are structured to secure the float assembly 200 to the wheel assembly 100 described herein. More specifically, the hooks 210 are structured to engage with the axle 112 of the wheel assembly 100 at the gaps 119, 121 described with reference to FIG. 3. In other words, the hooks 210 are received in the gaps 119, 121 and are secured around the axle 112 with the flanges 117 securing the hooks 210 in position on the axle 112.

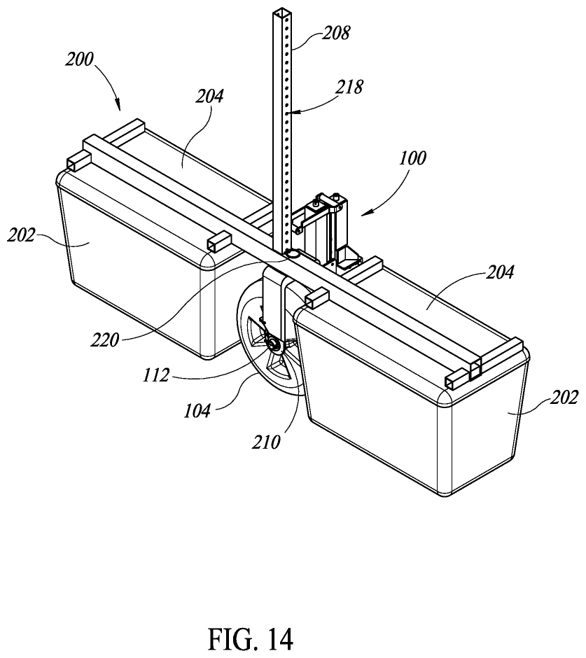

FIG. 14 is an axonometric view of the float assembly 200 removably coupled to the wheel assembly 100 described herein with the hooks 210 of the fork 208 received in the gaps 119, 121 (see FIG. 3) on the axle 112 and coupled around the axle 112 of the wheel assembly 100. As shown in FIG. 14, the float assembly 200 is structured such that one float 202 is on either side of the wheel 104 and the fork 208 and hooks 210 do not interfere with rotation of the wheel 104 on the axle 112. Further, in some implementations, the combined system 100, 200 is collapsible and storable inside the floats 202. Specifically, the floats 202 and lids 204 are tapered and are designed to nest with each other such that two boxes and lids nest together. Further, the fork 208 and frame 206 can be disassembled and stored inside one of the nested floats 202 along with the wheel assembly 100. As such, the design of the wheel assembly 100 and the float assembly 200 minimizes the space needed for storage or transportation. In some implementations, the floats 202 may have two small wheels on one end with a handle at the other, such that the floats can be more easily transported or moved.

In use on a boatlift positioned in a body of water, one or more wheel assemblies 100 are attached to the boat lift side rails (such as support 172 in FIG. 1) as described herein. Two flotation assemblies 200 are put together and floated out to the lift, one assembly 200 to each side of the boatlift. On each float assembly 200, the pin 220 holding the fork 208 in the aperture 216 in the center of each fork 208 is removed and the fork 208 is lowered and hooked to the axle 112 of a respective wheel assembly 100. The pin 220 is re-inserted in the lowest possible hole 218 on the fork 208 of each float assembly 200. The wheel assemblies 100 are manipulated to extend the second translation assembly 108 (with an adjustment to the slide assembly 100 if needed) and the wheel 104 until the lift floats via the floats 202 on the flotation assembly 200. Then, the lift is moved from its initial position to its destination via a combination of the floats 202 and the wheels 104. In other words, the floats 202 are utilized until the lift reaches shallower water, wherein the wheel assemblies 100 can be manipulated to utilize the wheels 104 to finish moving the boatlift to its intended destination. Further, if flotation assemblies 200 are installed with wheel assemblies 100 positioned at the forward and aft ends of the boatlift, then the flotation assemblies 200 will also help reduce “jamming” into uneven terrain in low water.

When the boatlift is placed at its final destination, the wheel assemblies 100 are manipulated to raise the wheels 104 until the boat lift once again rests on its own feet. Then, the pin 220 can be removed from the fork 208 removed for further disassembly of the float assembly 200. In some implementations, the wheel assembly 100 is sold as a kit including the wheel assembly 100 and replacement parts, such as different wheels for different terrain and use conditions, in one non-limiting example. In some implementations, the flotation assembly 200 is sold as a kit with replacement parts, such as with different size floats 202 and lids 204 to vary the amount of flotation provided by the flotation assembly 200, either as part of one kit with the wheel assembly 100 or as part of a different kit.

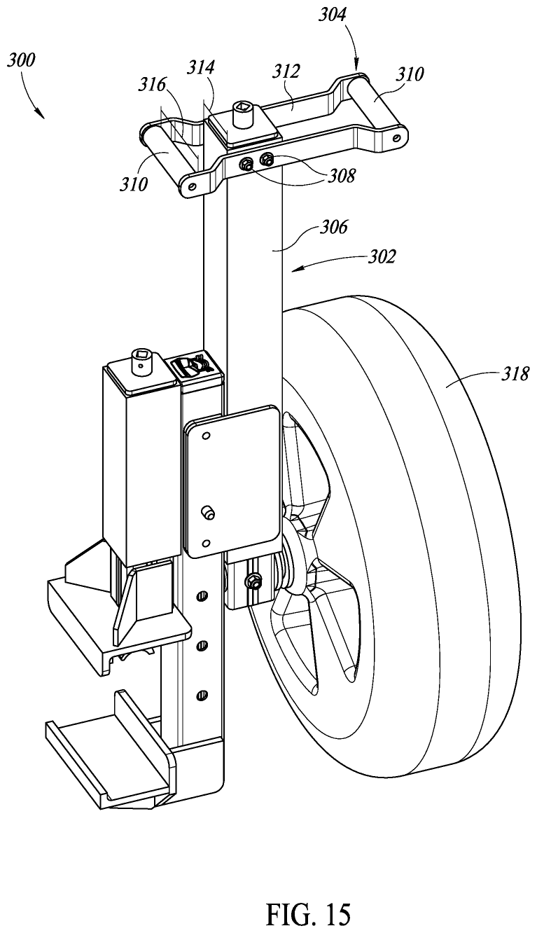

FIG. 15 is an axonometric view of a detachable wheel assembly 300 according to one more implementations. The wheel assembly 300 may be identical to wheel assembly 100 except as otherwise described herein. The wheel assembly 300 includes a translation assembly 302 and a handle assembly 304 coupled to an outer tube 306 of the translation assembly 302 with fasteners, such as nut and bolt assemblies 308. In some implementations, the handle assembly 304 is also coupled to an inner tube of the translation assembly 302 with similar fasteners. In the illustrated implementation, the handle assembly 304 includes two handles 310 on opposing first and second sides of the outer tube 306 coupled to each other and the outer tube 306 by links 312. The fasteners 308 coupled the links 312 to the outer tube 306 on third and fourth opposing sides of the outer tube 306. In some implementations, the links 312 are replaced by connecting plates, clamps or another like support structure. The links 312 are spaced by a first distance 314 proximate the outer tube 306 that is less than a second distance 316 between the links 312 at the handles 310 of the handle assembly 304, as shown in FIG. 15. The difference between the distances 314, 316 enables a user to more easily grasp the handles, while also enabling the links 312 to be attached to the outer tube 306.

As such, the links 312 are adjacent and in abutting contact with the outer tube 306, in some implementations. The handle assembly 304 is also removable by removing the fasteners 308 securing the links 312 to the outer tube 306, such as for storage. In use, the handle assembly 304 assists with moving the wheel assembly 100 when the wheel assembly 100 is not in use, and may also assist with moving a structure attached to the wheel assembly 100 when the wheel assembly 100 is in use. In one non-limiting example, when the wheel assembly 100 is secured to a structure, a user can grasp either or both of the handles of the handle assembly 174 to assist with moving the structure (e.g., pushing or pulling on the handles to cause movement of the structure while walking alongside the wheel assembly 100). In some implementations, the handles 310 are spaced from the outer tube 306 at different distances such that one handle proximate a wheel 318 of the assembly 300 can more easily be used for moving the structure attached to the assembly 300. However, offset spacing of the handles 310 is not required and the handles 310 may be spaced equidistant from the outer tube 306 in some implementations. Further, there may be only one handle 310 in the assembly 304 instead of the two handles 310 illustrated in FIG. 15.

In the foregoing description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with boatlifts and wheel assemblies have not been shown or described in detail to avoid unnecessarily obscuring descriptions of the implementations.

Unless the context requires otherwise, throughout the specification and claims which follow, the word “comprise” and variations thereof, such as, “comprises” and “comprising” are to be construed in an open, inclusive sense, that is as “including, but not limited to.” Further, the terms “first,” “second,” and similar indicators of sequence are to be construed as interchangeable unless the context clearly dictates otherwise.

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The relative terms “approximately” and “substantially,” when used to describe a value, amount, quantity, or dimension, generally refer to a value, amount, quantity, or dimension that is within plus or minus 5% of the stated value, amount, quantity, or dimension, unless the content clearly dictates otherwise.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not to be limited by the disclosure.

1. A detachable wheel assembly, comprising:
a clamp including a first jaw and a second jaw;
a first translation assembly coupled to the first jaw and structured to move the first jaw towards and away from the second jaw;
a slide assembly coupled to the first translation assembly and to the second jaw and structured to move the second jaw towards and away from the first jaw;
a wheel axle; and
a second translation assembly coupled to the first translation assembly, the slide assembly, and the wheel axle, the second translation assembly structured to move the first translation assembly and the slide assembly towards and away from the wheel axle.

2. The detachable wheel assembly of claim 1 further including a first pair of flanges and a second pair of flanges coupled to the axle, the first pair of flanges separated by a first distance and the second pair of flanges separated by a second distance.

3. The detachable wheel assembly of claim 2 further comprising:
a float assembly including:
a fork having one or more hooks structured to be coupled to the wheel axle between a corresponding one of the first pair of flanges and the second pair of flanges;
a frame coupled to the fork; and
one or more floats coupled to the frame,
wherein the fork is structured to move toward and away from the frame to adjust a position of the one or more floats relative to the wheel axle.

4. The detachable wheel assembly of claim 3 wherein the one or more floats includes a first float and a second float, the first float and the second float positioned on opposite sides of a wheel coupled to the wheel axle.

5. The detachable wheel assembly of claim 1 wherein the slide assembly includes:
a tube coupled to the second jaw of the clamp, the tube including a plurality of first holes through the tube;
a plate coupled to the second translation assembly and including a second hole through the first plate; and
a pin structured to be received in at least one of the plurality of first holes and the second hole, wherein a position of the plate is adjustable relative to the tube by removing the pin, sliding the plate assembly along the tube, and inserting the pin in a different one of the plurality of first holes.

6. The detachable wheel assembly of claim 5 wherein the plurality of first holes are a plurality of first pairs of holes through the tube and the plate is a first plate, the slide assembly further including:
a second plate coupled to the second translation assembly and including a third hole through the second plate, wherein the position of the first plate and the second plate is adjustable relative to the tube by removing the pin, sliding the first plate and the second plate along the tube, and inserting the pin in one of the plurality of first pairs of holes, the second hole, and the third hole.

7. The detachable wheel assembly of claim 1 further comprising:
a handle assembly coupled to the second translation assembly.

8. The detachable wheel assembly of 7 wherein the handle assembly includes a pair of links coupled to the second translation assembly and a first handle and a second handle coupled to the pair of links, the first handle and the second handle positioned on opposite sides of the second translation assembly.

9. A detachable wheel assembly, comprising:
a clamp;
a first translation assembly coupled to the clamp;
a slide assembly coupled to the clamp;
a second translation assembly coupled to the slide assembly; and
an axle coupled to the second translation assembly.

10. The detachable wheel assembly of claim 9 wherein the clamp includes a first jaw and a second jaw, the first jaw coupled to the first translation assembly and the second jaw coupled to the slide assembly, the first jaw further including a flat portion and a recess, wherein the recess defines sidewalls that are flat, curved or sloped.

11. The detachable wheel assembly of claim 9 further comprising:
a float assembly including:
a fork structured to be coupled to the axle;
a frame coupled to the fork; and
one or more floats coupled to the frame,
wherein the fork is structured to move toward and away from the frame to adjust a position of the one or more floats relative to the axle.

12. The detachable wheel assembly of claim 9 wherein the first translation assembly includes:
a first tube coupled to the clamp;
a second tube structured to slidably receive the first tube in a telescoping manner;
a first screw coupled to the second tube and extending through at least one wall of each of the first and second tubes; and
a first nut on the first screw, the first nut coupled to the first tube and structured to translate along the first screw in response to rotation of the first screw.

13. The detachable wheel assembly of claim 9 wherein the second translation assembly includes:
an inner tube coupled to the axle;
an outer tube structured to slidably receive the inner tube;
a second screw coupled to the outer tube and extending through at least one wall of each of the inner and outer tubes; and
a second nut on the second screw, the second nut coupled to the inner tube and structured to translate along the second screw in response to rotation of the second screw.

14. The detachable wheel assembly of claim 9 further comprising:
a handle assembly coupled to the second translation assembly, including two handles on opposing sides of the second translation assembly connected to each other by links coupled to the second translation assembly.

15. The detachable wheel assembly of claim 9 wherein the slide assembly includes:
a central tube coupled to the clamp and having a first side and a second side opposite the first side with a plurality of pairs of first holes extending through the first and second sides of the central tube, each pair of first holes of the plurality of pairs of first holes spaced relative to each other pair of first holes along a height of the central tube;
a first plate assembly coupled to the second translation assembly and having a second hole extending through the first plate assembly;
a second plate assembly coupled to the second translation assembly and having a third hole extending through the second plate assembly; and
a pin structured to be received in one of the pairs of the first holes, the second hole, and the third hole, wherein a position of the first and second plate assemblies relative to the central tube is adjustable by removing the pin, sliding the plate assemblies along the central tube, and inserting the pin in a different pair of the plurality of pairs of first holes, the second hole, and the third hole.

16. A method, comprising:
adjusting a slide assembly coupled to a first jaw of a clamp until the first jaw of the clamp is in physical contact with a support of a structure;
rotating a first screw of a first translation assembly coupled to a second jaw of the clamp until the second jaw of the clamp is in physical contact with the support of the structure;
rotating a second screw of a second translation assembly coupled to an axle to adjust a height of the axle and a height of a wheel coupled to the axle relative to the support;
moving the structure from a first location to a second location; and
removing the clamp from the support of the structure.

17. The method of claim 16 further comprising:
removing a pin from one hole of a plurality of holes in a fork of a float assembly;
adjusting the fork relative to a support of the float assembly;
coupling hooks coupled to the fork to the axle;
inserting the pin into a different hole of the plurality holes; and
rotating the second screw of the second translation assembly.

18. The method of claim 16 wherein adjusting the slide assembly includes:
removing a pin from a first hole in a first plate coupled to the second translation assembly, a second hole in a second plate coupled to the second translation assembly, and one pair of holes of a plurality of pairs of holes in a tube of the slide assembly coupled to the first jaw of the clamp;
sliding the first plate and the second plate along the tube; and
inserting the pin into a different pair of holes of the plurality of pairs of holes, the first hole, and the second hole.

19. The method of claim 16 wherein rotating the first screw of the first translation assembly includes adjusting a height of a first tube relative to a second tube of the first translation assembly, the rotating including translating a first nut coupled to the first tube along the first screw via rotation of the first screw.

20. The method of claim 19 wherein rotating the second screw of the second translation assembly includes adjusting a height of a third tube relative to a fourth tube of the second translation assembly, the rotating including translating a second nut coupled to the third tube along the second screw via rotation of the second screw.
